(19) United States
(12) Patent Application Publication
(10) Pub. No.: US 2009/0278871 A1
(43) Pub. Date: Nov. 12, 2009

(54) Controlling Display Resolution Of A Computer Display

(75) Inventors: Thomas F. Lewis, Raleigh, NC (US); Robert M. Piper, Apex, NC (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/118,081

(22) Filed: May 9, 2008

(51) Int. Cl. G09G 5/02

(52) U.S. Cl. 345/698

(57) ABSTRACT

Methods, apparatus, and products for controlling display resolution of a computer display, the computer display connected through a display resolution controller to a computer, including: retrieving, by a display resolution controller from a computer display, extended display identification data (‘EDID’) of the computer display, the EDID including an actual maximum display resolution of the computer display, the EDID stored in computer memory of the computer display; replacing, by the display resolution controller, the actual maximum display resolution of the computer display with a limited maximum display resolution of the computer display if the limited maximum display resolution is less than the actual maximum display resolution of the computer display; and providing the EDID including the limited maximum display resolution to the computer for displaying video at the limited maximum display resolution.

### BACKGROUND OF THE INVENTION

1. Field of the Invention

The field of the invention is data processing, or, more specifically, methods, apparatus, and products for controlling display resolution of a computer display.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Some computer systems today may be operated remotely through another computer over a data communications network. To accomplish this task, video graphics local to the remotely operated computer system are compressed and transmitted over the data communications network to the other computer system for display on a monitor connected to that other computer system. The higher the resolution of the local display of the remotely operated computer system, the greater the amount of bandwidth required for transmitting the compressed video graphics across the data communications network and conversely, the lower the resolution of the display, the lower the amount of bandwidth required for such transmission.

### SUMMARY OF THE INVENTION

Methods, apparatus, and products for controlling display resolution of a computer display, the computer display connected through a display resolution controller to a computer, including: retrieving, by a display resolution controller from a computer display, extended display identification data (‘EDID’) of the computer display, the EDID including an actual maximum display resolution of the computer display, the EDID stored in computer memory of the computer display; replacing, by the display resolution controller, the actual maximum display resolution of the computer display with a limited maximum display resolution of the computer display if the limited maximum display resolution is less than the actual maximum display resolution of the computer display; and providing the EDID including the limited maximum display resolution to the computer for displaying video at the limited maximum display resolution.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an example system for controlling display resolution of a computer display according to embodiments of the present invention.

FIG. 2 sets forth a flow chart illustrating an exemplary method for controlling display resolution of a computer display according to embodiments of the present invention.

### DETAILED DESCRIPTION OF EXEMPLARY EMBODIMENTS

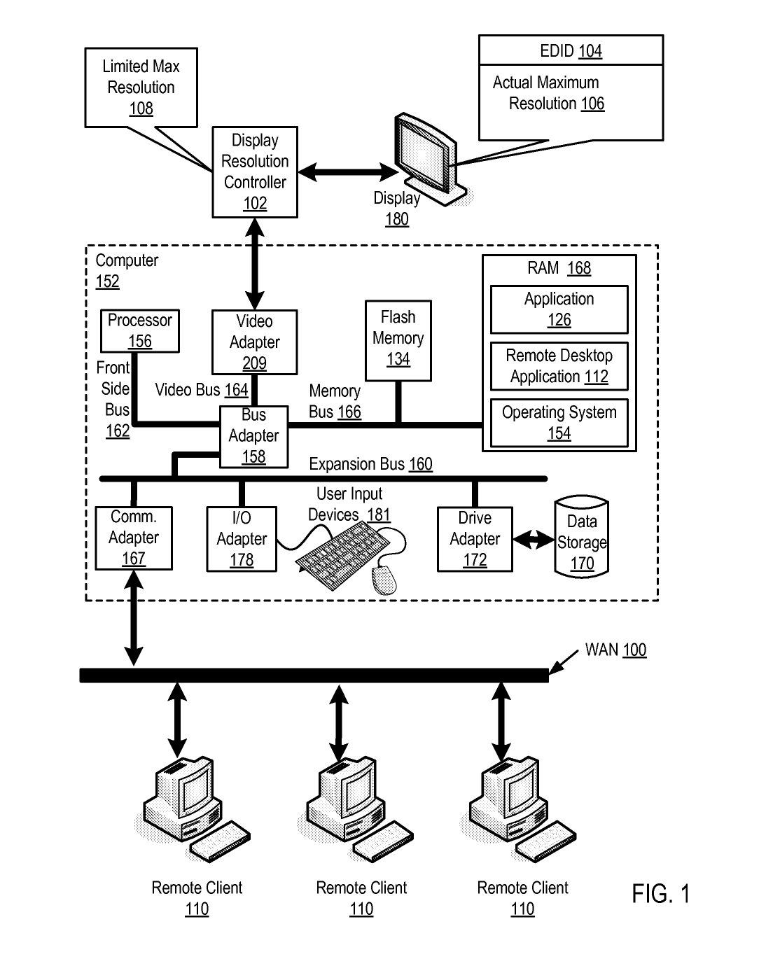

Exemplary methods, apparatus, and products for controlling display resolution of a computer display in accordance with the present invention are described with reference to the accompanying drawings, beginning with FIG. 1. FIG. 1 sets forth a functional block diagram of an example system for controlling display resolution of a computer display according to embodiments of the present invention. The system of FIG. 1 includes a computer (152) which in turn includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a software application (126), a set of computer program instructions for user-level data processing. Examples of such software applications include word processors, spreadsheet applications, media players, and so on as will occur to those of skill in the art. Also stored in RAM is a remote desktop application (112), a set of computer program instructions that provide remote access and remote administration of graphical user interface applications, such as the software application (126) that are executed remotely on the computer (152) and displayed locally on a display connected to the remote client. That is, when a remote client (110) connects through the WAN (100) to the computer (152) and the remote desktop application (112) is executing on the computer (152), the remote client (110) and the computer (152) function in a client-server relationship, where the computer (152) operates as a server. The remote client (110) then may execute software on the computer (152) and display locally all graphics typically displayed on the computer display (180) connected to the computer (152). The remote client (110) may be said to be ‘remotely controlling’ the computer (152).

Also stored in RAM (168) is an operating system (154). Operating systems useful in systems for mapping power domains in a data center according to embodiments of the present invention include UNIX™, Linux™, Microsoft XP™, Microsoft Vista™, AIX™, IBM's i5/OS™, and others as will occur to those of skill in the art. The operating system (154), the software application (126), and the remote desktop application (112) in the example of FIG. 1 are shown in RAM (168), but many components of such software typically are stored in non-volatile memory also, such as, for example, on a disk drive (170) or in flash memory (134). The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for mapping power domains in a data center according to embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory) (134), RAM drives, and so on, as will occur to those of skill in the art.

The exemplary computer (152) of FIG. 1 includes a communications adapter (167) for data communications with other computers and for data communications with a wide area network (“WAN”) (100), a data communications network. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for mapping power domains in a data center according to embodiments of the present invention include modems for wired dial-up communications, Ethernet (IEEE 802.3) adapters for wired data communications network communications, and 802.11 adapters for wireless data communications network communications.

As mentioned above the computer (152) and remote client (110) in the example of FIG. 1 may be organized in a remote data processing environment, with the remote client connected in a client-server relationship to the computer (152) through the WAN (100) for remote control of the computer. A remote client is automated computing machinery, such as a computer, capable of data communications and remote connection through a data communications network to another computer. Just as a remote desktop application (112) provides server-side access and control to a client, the remote clients (110) may also execute client-side remote desktop applications that establish communications with the computer (152) and administer client-side data processing tasks.

In such a remote desktop environment graphics typically displayed on the computer display (180) connected to the computer (152) are streamed through the wide area network (100) to a remote client (110) for display on a computer display connected to the remote client (110), such as a monitor. The higher the display resolution of graphics for display on the computer display (180) of the server-side computer (152), the greater the bandwidth used to stream the graphics over the WAN. One way to limit the amount of bandwidth required to stream such graphics to a remote client is to limit the display resolution of a computer display (180). Display resolution as the term is used in the specification refers to the number of distinct pixels in each dimension that can be displayed on the computer display (180). Examples of typical display resolutions include 1680×1050, 1280×720, 1024×769 and so on as will occur to those of skill in the art. Changing a resolution from 1680×1050 to 1024×769 for example will lower the amount of bandwidth required to transmit each frame of graphics to a remote client because fewer pixels, and therefore less data, per frame will be streamed.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The video adapter (209) in the example of FIG. 1 is connected to the display (180) through a display resolution controller (102). A display resolution controller (102) is an aggregation of computer hardware and software that adapts one or more computer displays to the computer and controls the display resolution of the computer displays. Such a display resolution controller may be implemented external to the computer, as depicted in the example of FIG. 1, or may be implemented as part of the computer. Such an aggregation of computer hardware and software may be implemented with a computer processor and RAM, a microcomputer, as a reconfigurable logic block of programmable logic components, such as a Field Programmable Gate Array (‘FPGA’), as a combination of synchronous and asynchronous logic, or in other ways as will occur to those of skill in the art.

As mentioned above the display resolution controller (102) of FIG. 1 is capable of controlling the display resolution of a computer display (180) in accordance with embodiments of the present invention. The display resolution controller (102) operates generally for controlling the display resolution of the computer display (180) by retrieving, from a computer display (180), extended display identification data (‘EDID’) (104) of the computer display. EDID is a data structure stored in memory of a computer display that describes the computer display's capabilities. EDID enables a modern personal computer to determine a type of monitor that is connected to the personal computer. Examples of information typically described in EDID include a manufacturer name, product type, phosphor or filter type, timings supported by the display, display size, luminance data and pixel mapping data. The EDID (104) in the example of FIG. 1 includes an actual maximum display resolution (106) of the computer display (180) and is stored in computer memory of the computer display (180). When connected directly to a computer system a computer display may transmit the EDID from the display to a video adapter (209) through a Display Data Channel version 2 (‘DDC2’) which is typically implemented as an I²C bus in a VGA cable that electrically connects the display and the computer.

The display resolution controller (102) may also control display resolution of a computer display by replacing the actual maximum display resolution (106) of the computer display (180) with a limited maximum display resolution (108) of the computer display (180) if the limited maximum display resolution (180) is less than the actual maximum display resolution (106) of the computer display. The display resolution controller then may provide the EDID (104) including the limited maximum display resolution (108) to the computer (152) for displaying video at the limited maximum display resolution (108).

The arrangement of computers, remote clients, servers, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

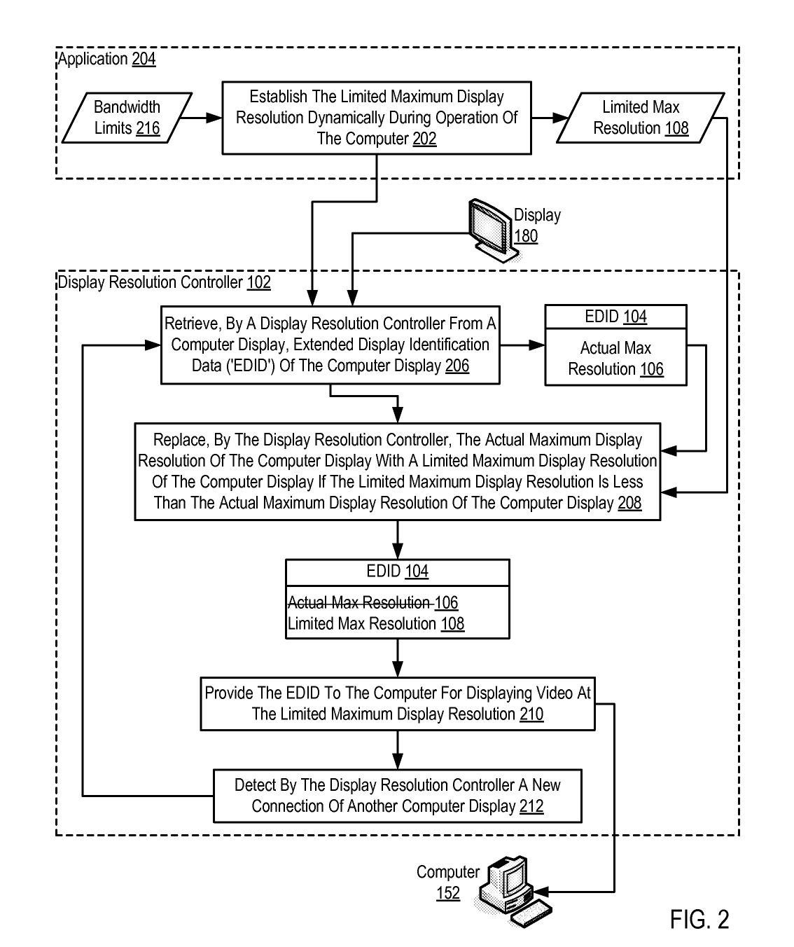

For further explanation, FIG. 2 sets forth a flow chart illustrating an exemplary method for controlling display resolution of a computer display according to embodiments of the present invention. The computer display (180) in the example of FIG. 2 is connected through a display resolution controller (102) to a computer (152).

The method of FIG. 2 includes retrieving (206), by a display resolution controller (102) from a computer display (180), extended display identification data (‘EDID’) (104) of the computer display (180). In the method of FIG. 2, the EDID (104) includes an actual maximum display resolution (106) of the computer display (180) and the EDID (104) is stored in computer memory of the computer display (180). Retrieving (206) EDID (104) of the computer display (180) may be carried out by reading the data from a segment of a computer memory in the computer display, such as serial programmable read-only memory (‘PROM’) or electrically erasable PROM (‘EEPROM’) through a DDC2, described above.

The method of FIG. 2 also includes replacing (208), by the display resolution controller (102), the actual maximum display resolution (106) of the computer display (180) with a limited maximum display resolution (108) of the computer display if the limited maximum display resolution (108) is less than the actual maximum display resolution (106) of the computer display (180). A limited maximum display resolution is the maximum display resolution allowed for a display connected to the computer system through the display resolution controller. Such a limited maximum display may be less than the actual maximum display resolution of the display. Consider as an example a display with an actual maximum display resolution of 1280×720. A limited maximum display resolution for such a display may be a resolution of 1024×786, 800×600, and so on.

Replacing (208), by the display resolution controller (102), the actual maximum display resolution (106) of the computer display (180) with a limited maximum display resolution (108) of the computer display if the limited maximum display resolution (108) is less than the actual maximum display resolution (106) of the computer display (180) may be carried out by removing the actual maximum display resolution (106) from the EDID data structure and storing the limited maximum display resolution (108) in the EDID data structure in a format conforming to the data format of the EDID data structure. A limited maximum display resolution is a value representing a display resolution that is less than an actual maximum display resolution of a computer display.

A limited maximum resolution (108) may be may be a user-defined value or may be a preset value established in the display resolution controller by a manufacturer of the display resolution controller. As an alternative to a limited maximum resolution that is user-defined or established by a manufactured of the display resolution controller (102), the limited maximum display resolution (108) in the method of FIG. 2 may also be established dynamically during operation of the computer by an application (204) executing on the computer (152), such as a remote desktop application (112 in FIG. 1), in dependence upon bandwidth limits (216) of one or more remote clients capable of remote control of the computer. Such bandwidth limits (216) describe the maximum amount of bandwidth available for data communications between the computer (152) and the remote client. An application may determine a display resolution in dependence upon the bandwidth limits by looking up a display resolution associated with the bandwidth limit of the remote client in a table associating display resolution and ranges of bandwidth limits. Some remote clients for example may connect to a wide area network to the computer (152) through a variety of connections such as a low-bandwidth dial-up modem, a higher bandwidth cable or digital subscriber line (‘DSL’) modem, or an even higher bandwidth TI or ISDN connection. Bandwidth limits for remote clients connecting to a WAN via any of these connections may be set for the client in dependence upon their connection type.

The method of FIG. 2 also includes providing (210) the EDID (104) including the limited maximum display resolution (108) to the computer (152) for displaying video at the limited maximum display resolution (108). Providing (210) the EDID (104) including the limited maximum display resolution (108) to the computer (152) for displaying video at the limited maximum display resolution (108) may be carried out by transmitting, to the computer upon request from the computer, the EDID information through a DDC2 connecting the display resolution controller (102) to a video adapter of the computer (152). That is, in some embodiments, from the point of view of the computer (152), the display resolution controller is transparent and the computer appears to retrieve EDID directly from the computer display. And from the point of view of the display (180), the display resolution controller (102) is also transparent such that the computer itself appears to retrieve the EDID directly from the display (180).

The method of FIG. 2 also includes detecting (212) by the display resolution controller (102) a new connection of another computer display. Detecting (212) by the display resolution controller (102) a new connection of another computer display may be carried out by providing by the display resolution controller, one or more plug-and-play signal lines electrically connected to a display upon connection of the display to the display resolution controller and identifying a change in the plug-and-play signal lines. That is, in some embodiments of the present invention, upon connection of a display to the display resolution controller, the voltage level on a particular signal line changes states, from high to low or low to high, for example, and the display resolution controller (102) detects the connection of the display. Such a display resolution controller therefore may make such a detection in real-time or near-real-time and may enable connection of multiple computer displays, limiting the display resolution of each.

Exemplary embodiments of the present invention are described largely in the context of a fully functional computer system for controlling display resolution of a computer display. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling display resolution of a computer display, the computer display connected through a display resolution controller to a computer, the method comprising:
retrieving, by a display resolution controller from a computer display, extended display identification data (‘EDID’) of the computer display, the EDID including an actual maximum display resolution of the computer display, the EDID stored in computer memory of the computer display;
replacing, by the display resolution controller, the actual maximum display resolution of the computer display with a limited maximum display resolution of the computer display if the limited maximum display resolution is less than the actual maximum display resolution of the computer display; and
providing the EDID including the limited maximum display resolution to the computer for displaying video at the limited maximum display resolution.

2. The method of claim 1 further comprising:
detecting by the display resolution controller a new connection of another computer display.

3. The method of claim 1 wherein the limited maximum display resolution is a user-defined value.

4. The method of claim 1 wherein the limited maximum display resolution is established as a preset in the display resolution controller by a manufacturer of the display resolution controller.

5. The method of claim 1 further comprising:
establishing, by an application executing on the computer in dependence upon bandwidth limits of one or more remote clients capable of remote control of the computer, the limited maximum display resolution dynamically during operation of the computer.

6. The method of claim 1 wherein the display resolution controller further comprises an aggregation of computer hardware and software implemented as part of the computer that adapts one or more computer displays to the computer.

7. The method of claim 1 wherein the display resolution controller further comprises an aggregation of computer hardware and software implemented external to the computer that adapts one or more computer displays to the computer.

8. An apparatus for controlling display resolution of a computer display, the computer display connected through a display resolution controller to a computer, the apparatus comprising a computer processor, a computer memory operatively coupled to the computer processor, the computer memory having disposed within it computer program instructions capable of:
retrieving, by a display resolution controller from a computer display, extended display identification data (‘EDID’) of the computer display, the EDID including an actual maximum display resolution of the computer display, the EDID stored in computer memory of the computer display;
replacing, by the display resolution controller, the actual maximum display resolution of the computer display with a limited maximum display resolution of the computer display if the limited maximum display resolution is less than the actual maximum display resolution of the computer display; and
providing the EDID including the limited maximum display resolution to the computer for displaying video at the limited maximum display resolution.

9. The apparatus of claim 8 further comprising computer program instructions capable of:
detecting by the display resolution controller a new connection of another computer display.

10. The apparatus of claim 8 wherein the limited maximum display resolution is a user-defined value.

11. The apparatus of claim 8 wherein the limited maximum display resolution is established as a preset in the display resolution controller by a manufacturer of the display resolution controller.

12. The apparatus of claim 8 wherein the display resolution controller further comprises an aggregation of computer hardware and software implemented as part of the computer that adapts one or more computer displays to the computer.

13. The apparatus of claim 8 wherein the display resolution controller further comprises an aggregation of computer hardware and software implemented external to the computer that adapts one or more computer displays to the computer.

14. A computer program product for controlling display resolution of a computer display, the computer display connected through a display resolution controller to a computer, the computer program product disposed in a signal bearing medium, the computer program product comprising computer program instructions capable of:
retrieving, by a display resolution controller from a computer display, extended display identification data (‘EDID’) of the computer display, the EDID including an actual maximum display resolution of the computer display, the EDID stored in computer memory of the computer display;
replacing, by the display resolution controller, the actual maximum display resolution of the computer display with a limited maximum display resolution of the computer display if the limited maximum display resolution is less than the actual maximum display resolution of the computer display; and
providing the EDID including the limited maximum display resolution to the computer for displaying video at the limited maximum display resolution.

15. The computer program product of claim 14 further comprising computer program instructions capable of:
detecting by the display resolution controller a new connection of another computer display.

16. The computer program product of claim 14 wherein the limited maximum display resolution is a user-defined value.

17. The computer program product of claim 14 wherein the limited maximum display resolution is established as a preset in the display resolution controller by a manufacturer of the display resolution controller.

18. The computer program product of claim 14 wherein the display resolution controller further comprises an aggregation of computer hardware and software implemented as part of the computer that adapts one or more computer displays to the computer.

19. The computer program product of claim 14 wherein the display resolution controller further comprises an aggregation of computer hardware and software implemented external to the computer that adapts one or more computer displays to the computer.

20. The computer program product of claim 14 wherein the signal bearing medium comprises a recordable medium.
